(19) United States
(12) Patent Application Publication
(10) Pub. No.: US 2026/0371264 A1
(43) Pub. Date: Nov. 19, 2026

(54) MAXIMUM POWER REDUCTION (MPR) DESIGN FOR COVERAGE ENHANCEMENT

(71) Applicant: QUALCOMM Incorporated, San Diego, CA (US)

(72) Inventors: Jing JIANG, San Diego, CA (US); Jing LEI, San Diego, CA (US)

(21) Appl. No.: 19/677,377

(22) Filed: May 14, 2026

Related U.S. Application Data
(60) Provisional application No. 63/806,161, filed on May 15, 2025.

(51) Int. Cl. H04W 52/36; H04L 27/26

(52) U.S. Cl. CPC H04W 52/367; H04L 27/2678

(57) ABSTRACT

Certain aspects are directed towards a method for wireless communications at a user equipment (UE). The method generally includes: receiving, from a network entity, an allocation of resources to perform a transmission; and performing the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

### CROSS-REFERENCE TO RELATED APPLICATION

This application claims benefit of and priority to U.S. Provisional Application No. 63/806,161, filed May 15, 2025, which is hereby expressly incorporated by reference herein in its entirety as if fully set forth below and for all applicable purposes.

### FIELD OF THE DISCLOSURE

Aspects of the present disclosure relate to wireless communications, and more particularly, to techniques for setting a maximum power reduction (MPR) for transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects are directed towards a method for wireless communications at a user equipment (UE). The method generally includes: receiving, from a network entity, an allocation of resources to perform a transmission; and performing the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

Certain aspects are directed towards a method for wireless communications at a network entity. The method generally includes: transmitting, to a user equipment (UE), an allocation of resources to perform a transmission; and receiving the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIG. 4A, FIG. 4B, FIG. 4C, and FIG. 4D depict various example aspects of data structures for a wireless communications network.

FIG. 5 illustrates graphs showing edge, inner, and outer resource blocks (RBs) within a resource pool for different waveforms.

FIG. 6A and FIG. 6B are tables illustrating maximum power reduction (MPR) level settings for different power classes.

FIG. 7 illustrates example block diagrams for generating transmit waveforms.

FIG. 8 illustrates a graph showing contiguous and non-contiguous resource allocations within a channel bandwidth.

FIG. 9 is a diagram illustrating different zero-padding patterns in time domain (TD).

FIG. 10 is a timing diagram illustrating example operations for indicating additional MPR (A-MPR) to be applied, in accordance with certain aspects of the present disclosure.

FIG. 11 shows an example of a method of wireless communications at a user equipment (UE).

FIG. 12 shows an example of a method of wireless communications at a network entity.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for setting maximum power reduction (MPR) for signal transmission. Some communication technologies may use transmit waveforms with low peak-to-average-power ratio (PAPR) to facilitate an increase in transmit power and coverage enhancement. The PAPR associated with the transmission may be impacted by various factors, such as a gap between allocated resources or a zero-padding pattern used for the transmission. Depending on the PAPR associated with the transmission, the transmit power associated with the transmission may be adjusted (e.g., using MPR) to avoid interference (e.g., with other communications or adjacent bands). Certain aspects provide an MPR design to support low-PAPR transmit waveforms to facilitate coverage enhancements based on factors that consider the PAPR of the transmission. For example, in some aspects, MPR may be determined based on the size of a gap between allocated resources for a transmission or on a zero-padding pattern associated with the transmission, as described in more detail herein. In some aspects, the MPR may be determined based on whether multiple transmission (TX) chains (e.g., multiple antennas) are to be used for the transmission.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

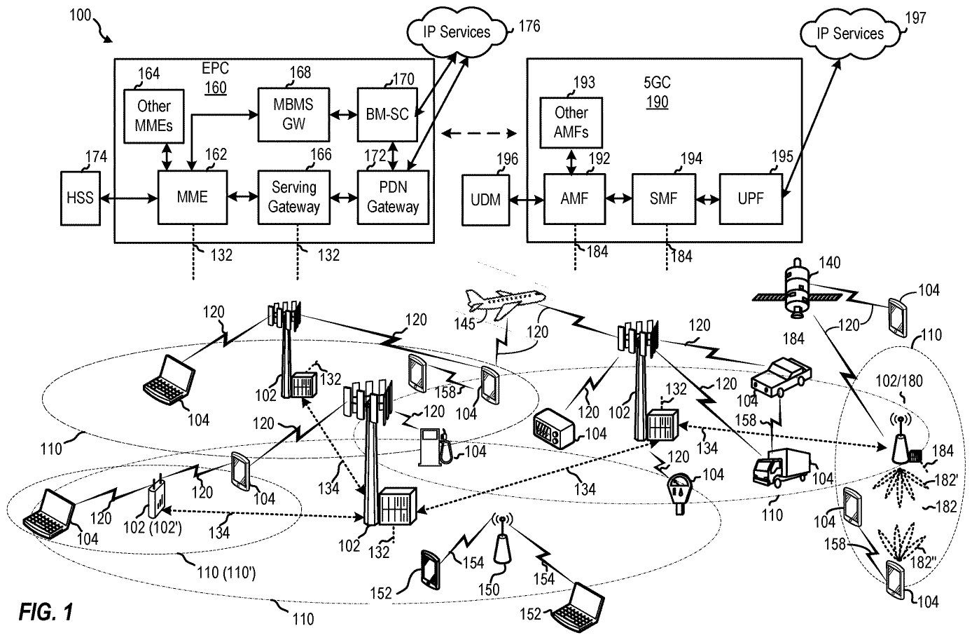

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

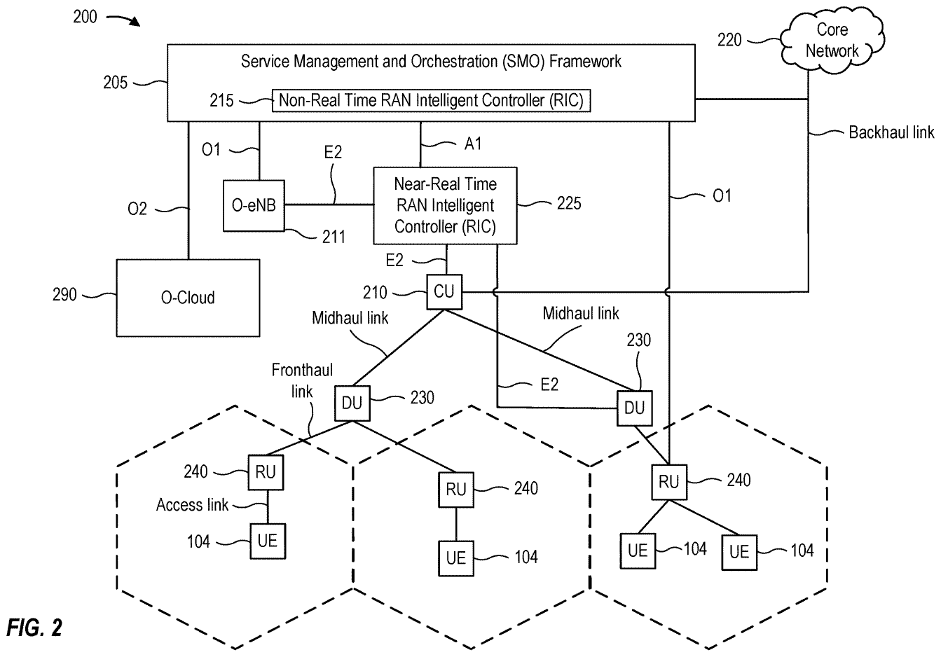

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

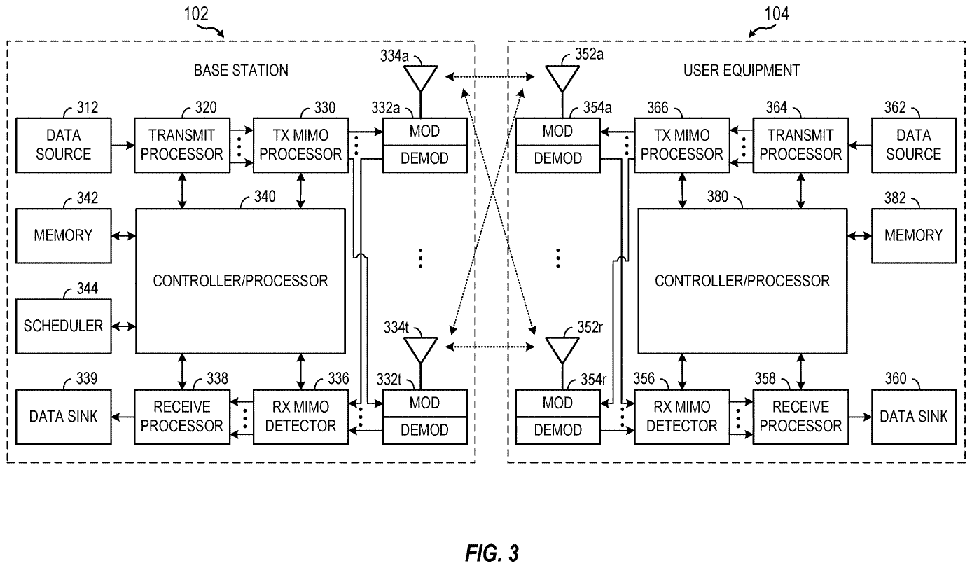

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

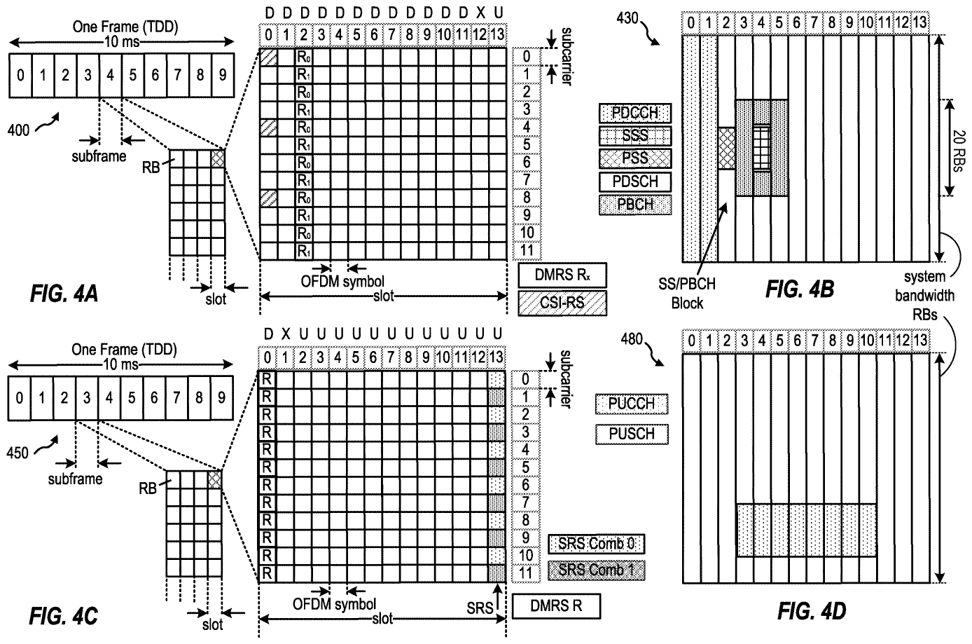

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Maximum Power Reduction (MPR) Design for Coverage Enhancement

Power consumption and coverage enhancements may be jointly designed at a user equipment (UE) and network in next-generation wireless technologies. Power consumption may be reduced with coverage enhancements while maintaining interoperability. The UE may enter a low-power mode to save energy and switch to normal or high power modes to increase performance. In some cases, a UE may enter an extended coverage mode to increase coverage.

In some cases, a UE may be implemented with maximum power reduction (MPR). For example, the UE may reduce the maximum output power during transmission to mitigate adjacent-channel leakage ratio (ACLR) or error vector magnitude (EVM) degradation. MPR may be applicable to a UE operating in time-division duplexing (TDD) or frequency-division duplexing (FDD) mode. MPR values (e.g., the level of power reduction) may depend on the modulation order used for transmission or on the location of the resource block (RB) allocation within a resource pool.

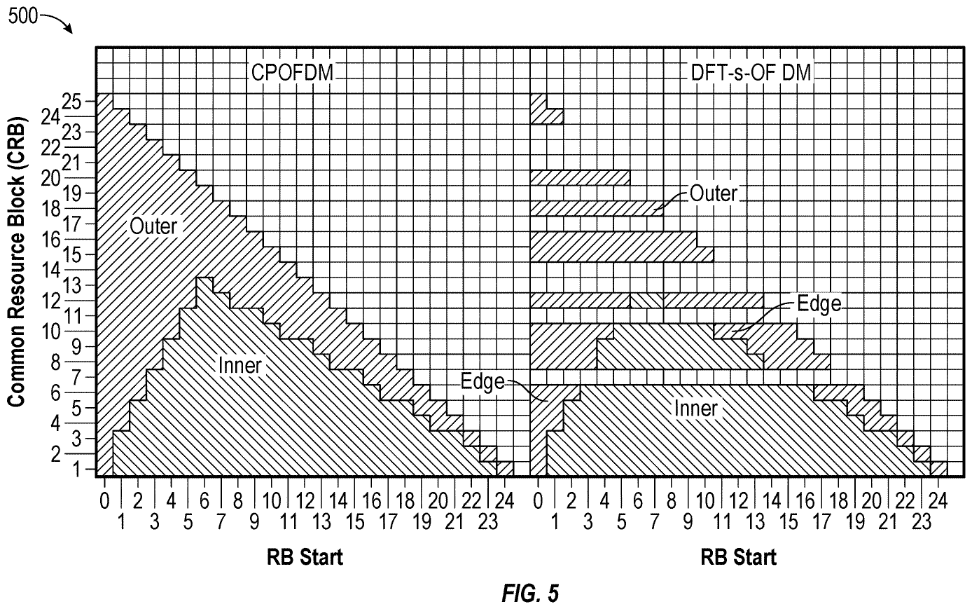

FIG. 5 illustrates graphs 500 showing edge, inner, and outer RBs within a resource pool for different waveforms (e.g., Discrete Fourier Transform-Spread-Orthogonal Frequency Division Multiplexing (DFT-s-OFDM) and Cyclic Prefix-Orthogonal Frequency Division Multiplexing (CP-OFDM)). To enhance UL coverage without causing resource fragmentation, frequency hopping of UL signals/channels may be configured near the edges of a carrier/sub-band/bandwidth part (BWP). For example, frequency hopping may be used for the DFT-s-OFDM waveform. The edge region corresponds to RBs located at the boundaries of the resource pool near the carrier edges. In some cases, the MPR level may be increased for edge RBs to reduce their transmission power and reduce interference with adjacent bands. When frequency hopping is configured near the carrier edge, the UE transmits close to the adjacent channel. Thus, the UE may reduce transmission power to mitigate RF impairments and interference to the adjacent channel. As a result, edge-configured frequency hopping may create MPR challenges that are addressed by the techniques described herein.

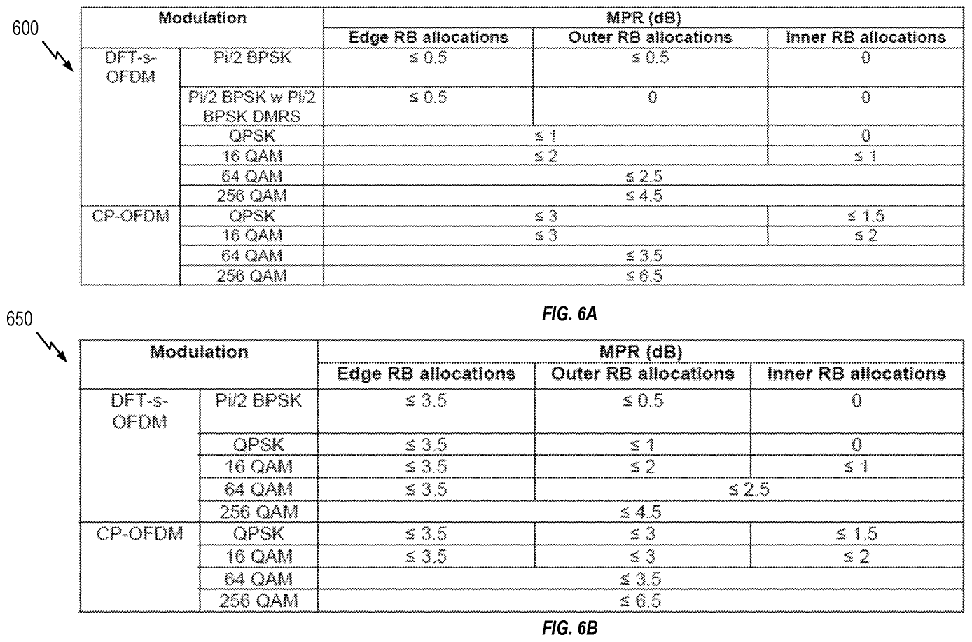

FIGS. 6A and 6B are tables 600, 650 illustrating MPR level settings for different power classes. As shown, MPR levels to be applied may be provided for waveforms including DFT-s-OFDM and CP-OFDM, and different modulation schemes including binary phase-shift keying (BPSK), quadrature phase-shift keying (QPSK), and quadrature amplitude modulation (QAM). The MPR levels may also be different for edge RBs (e.g., RBs on an edge of a resource pool), outer RBs (e.g., RBs on an outer part of a resource pool), and inner RBs (e.g., RBs on an inner part of a resource pool). For example, the MPR level may be increased for edge RBs so that the transmission power for the edge RBs is reduced to reduce the interference with adjacent bands.

Coverage enhancement on uplink (UL) signals/channels may be implemented for multiple UE types. The configuration of new waveform types with low peak-to-average-power ratio (PAPR) and/or multiple transmission (TX) ports may improve UL coverage. For example, transmission power may be increased when using a lower PAPR waveform, such as a resource spread multiple access (RSMA) TX waveform. Different PAPR characteristics, resource allocation schemes, and antenna couplings pose new challenges for the UE's power control and MPR handling. MPR enhancement to achieve a better tradeoff among coverage, power efficiency of UE, and interference management is described herein.

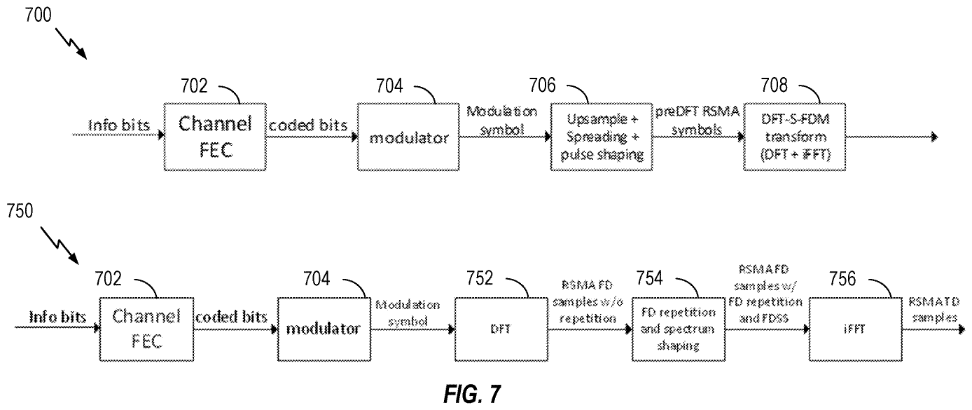

FIG. 7 illustrates example block diagrams for generating low PAPR RSMA TX waveforms. Block diagram 700 illustrates a time-domain pulse-shaping implementation for generating a low-PAPR RSMA TX waveform. As shown in block diagram 700, at block 702, channel FEC may be performed on information bits to generate coded bits. The coded bits are modulated at block 704 to generate modulation symbols, followed by upsampling, spreading, and pulse shaping at block 706 to generate pre-DFT RSMS symbols. A DFT-s-OFDM transform is then performed at block 708 to generate the low-PAPR RSMS TX waveform.

Block diagram 750 illustrates a frequency-domain (FD) repetition and spectrum-shaping implementation for generating a low PAPR RSMS TX waveform. As shown, at block 752, a discrete Fourier transform (DFT) may be performed on the modulation symbols to generate RSMA FD samples without repetition, followed by FD repetition and spectrum shaping at block 754 to generate RFMS FD samples with FD repetition and FD spectral shaping (FDSS). At block 756, an inverse FFT (iFFT) is performed to generate RSMA time domain (TD) samples. Thus, a low-PAPR RSMA waveform may be generated using TD spreading and pulse shaping or FD repetition and spectrum shaping.

In some implementations, a power amplifier (PA) is designed to operate efficiently to support a CP-OFDM waveform transmission for an enhanced mobile broadband (eMBB) UE. A PA of an IoT UE may be designed to operate more efficiently when transmitting a low-PAPR waveform (e.g., the low-PAPR RSMA waveform described with respect to FIG. 7) to improve the link budget (LB). That is, the PA of an IoT UE may be designed for efficiency with low-PAPR waveform transmissions, whereas eMBB UEs may be designed for efficiency with CP-OFDM waveform transmissions. This PA design difference may enable IoT UEs to achieve improved link budgets when using low-PAPR waveforms. Thus, a low PAPR waveform may increase the transmission power with a more efficient PA operation.

In some aspects of the present disclosure, support for low-PAPR waveforms on the UL may be specified in standards as a default or mandatory feature for IoT UEs. The low-PAPR waveform used in some IoT devices may support both contiguous and non-contiguous frequency-domain resource allocation.

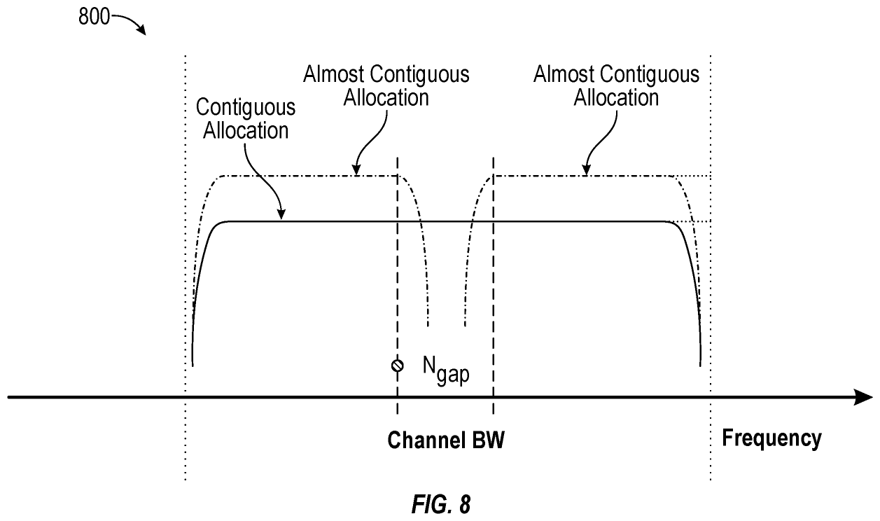

FIG. 8 illustrates a graph 800 showing contiguous and non-contiguous resource allocations within a channel bandwidth. A non-contiguous resource allocation allowed for a low PAPR waveform may have a gap (e.g., N_{gap}) of greater than zero RBs in the middle of N_{allocated} RBs, where N_{gap} is a positive integer representing the gap in terms of the number of RBs between the resource allocations and N_{allocated} is a positive integer representing the allocated number of RBs. The non-contiguous resource allocation may be associated with a threshold γ_{i,k} per the equation:

$$\frac{{N}_{gap}}{( {N}_{allocated} + {N}_{gap} )} < {γ}_{i , k}$$

where i and k denote the waveform type and UE type, respectively. A UE type may include a smartphone, customer premise equipment (CPE), a meter, or a sensor, to name a few examples. For a specific waveform and UE type, if the ratio between N_{gap} and the sum of N_{gap} and N_{allocated} is less than a threshold γ_{i,k}, the resource allocation may be considered as being almost contiguous and the MPR may be selected accordingly. Thus, one or more MPR tables may be provided for selecting an MPR depending on whether the resource allocation is contiguous, non-contiguous, or almost contiguous (e.g., is non-contiguous but the ratio between N_{gap} and the sum of N_{gap} and N_{allocated} is less than a threshold γ_{i,k}). In some cases, there may be three categories (contiguous, non-contiguous, and almost contiguous) with potentially different MPR tables for each. In some cases, almost contiguous allocations may reuse the contiguous MPR table. In some aspects, MPR tables (e.g., IoT-specific MPR tables) may be specified in standards for a low-PAPR waveform type i and UE type k, for both contiguous and non-contiguous resource allocations.

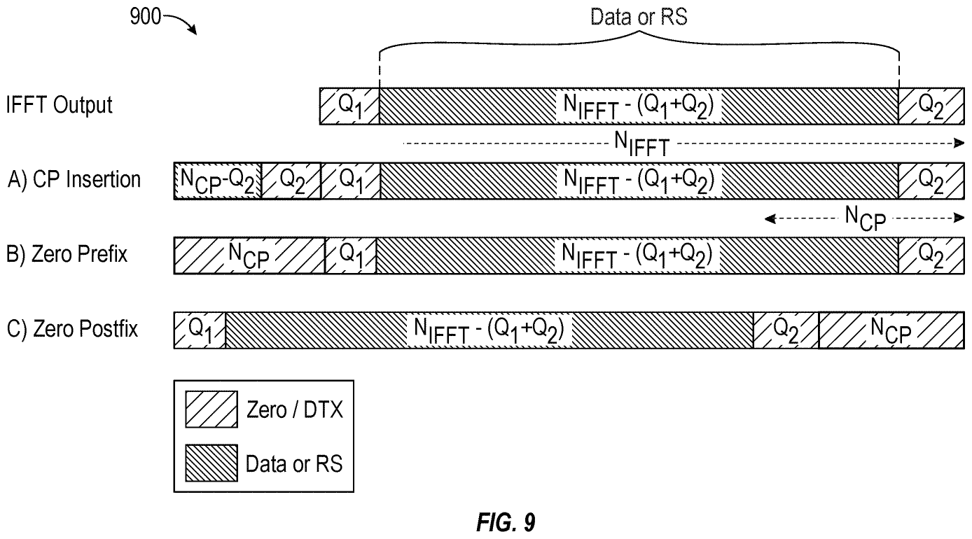

FIG. 9 is a diagram 900 illustrating different zero-padding patterns in the time domain (TD). As shown, an iFFT output may include N_{IFFT} samples, where N_{IFFT} is a positive integer, and may be implemented with discontinuous transmission (DTX). For example, Q₁ zero samples may be included before the data or reference signal (RS) samples, and Q₂ zero samples may be included after the data or RS samples. One zero-padding pattern may include cyclic prefix (CP) insertion (also referred to as “intra-CP”). As shown, a number (N_{CP}) of samples may be included before the Q1 zero samples, where the N_{CP} samples include a copy from the last portion of the N_{IFFT} samples (e.g., including the Q₂ zero samples and the last portion of the data or RS).

To accommodate coverage enhancement across different service types (e.g., communication, positioning, and sensing, such as integrated communication and sensing), zero-padding as a prefix/postfix for DFT-s-OFDM or CP-OFDM waveforms may be introduced to improve resilience to multipath delay spread and clutter rejection. For example, zero-padding may improve clutter rejection (e.g., for sensing applications in integrated communication and sensing scenarios. Clutter rejection in sensing applications refers to the ability to distinguish desired signal reflections from unwanted reflections caused by stationary or slow-moving objects in the environment (such as buildings, furniture, or terrain). Thus, a zero-padding pattern may include a zero-prefix pattern, which includes the number (N_{CP}) of zero samples preceding the Q₁ samples. Another zero-padding pattern is a zero-postfix pattern, which adds the number (N_{CP}) of zero samples after the Q2 samples. The zero-padding may increase the PAPR of the waveform. As a result, the UE may adjust the maximum TX power or a power headroom (PHR) calculation based on a new MPR table tailored to the zero-padding patterns.

In certain aspects of the present disclosure, a new MPR table may be provided in standards to account for the increased PAPR due to zero-padding. The amount of MPR may depend on the pattern of zero-padding (e.g., whether intra-CP, zero-prefix, or zero-postfix is used), the ratio of padded zeros (e.g., Q₁/N_{IFFT}, Q₂/N_{IFFT}, NCP/N_{IFFT}), modulation order, mode of bandwidth (BW) allocation (contiguous, non-contiguous), size of BW allocation, or any combination thereof.

To facilitate coverage enhancement on UL, dual-port transmission may be enabled for certain bottleneck channels (e.g., the physical uplink shared channel (PUSCH) or the physical uplink control channel (PUCCH) with a large payload) to improve TX diversity. For example, a PUSCH may be transmitted via two TX chains (e.g., via two antennas associated with the TX chains, respectively). In some cases, there may be insufficient isolation between antennas (e.g., especially in low-frequency bands), resulting in coupling/intermodulation distortion (IMD) that increases the adjacent channel leakage ratio (ACLR) and/or degrades the error vector magnitude (EVM) associated with the dual-port transmission. Due to the smartphone form factor, the antennas may not be distant enough, resulting in antenna correlation. As a result, additional MPR (A-MPR) may be configured to compensate for the impact of using two TX chains. In some cases, the network may signal A-MPR to the UE.

In certain aspects of the present disclosure, a new MPR table or A-MPR signaling may be specified for dual-port transmission to mitigate the negative impacts of IMD between two TX chains and meet the ACLR/EVM specifications, without compromising the full potential of TX diversity or UL multiple-input multiple-output (MIMO). In some aspects of the present disclosure, a new MPR table may be specified in standards to account for the correlation between multiple TX chains. In some aspects, new control signaling may be provided for A-MPR indication in downlink control information (DCI)/media access control-control element (MAC CE)/radio resource control (RRC), which is able to provide A-MPR separately for each TX chain, or jointly controls the amount of A-MPR for multiple TX chains simultaneously.

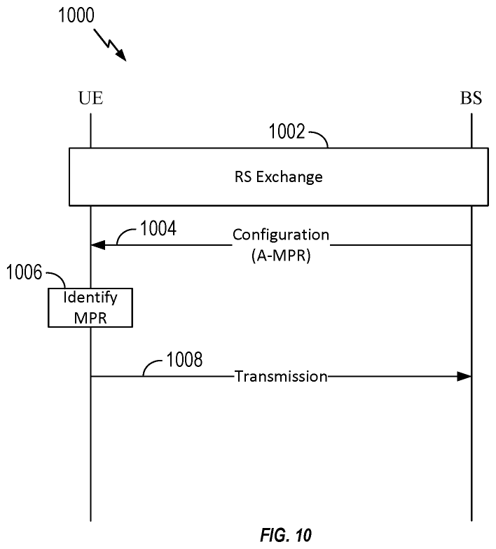

FIG. 10 is a timing diagram illustrating example operations 1000 for indicating A-MPR, in accordance with certain aspects of the present disclosure. At block 1002, reference signals (e.g., sounding reference signal (SRS) on uplink or channel state information reference signal (CSI-RS) on downlink) may be exchanged between the UE and the BS. Based on the SRS measured by the BS (e.g., or on CSI-RS measurements by the UE and reported to the BS under reciprocity), the BS may identify a condition associated with the UE. For example, the BS may determine whether the UE should transmit using a single or multiple antennas and, in some cases, identify coupling between the UE's antennas. Accordingly, the BS may transmit a configuration 1004 to the UE via one or more messages (e.g., DCI, MAC-CE or RRC message). In some cases, the configuration indicates whether the UE is to transmit using a single antenna or multiple antennas. When the network determines that one port is sufficient, it may configure the UE to use a single antenna (e.g., the better antenna) and indicate an A-MPR for that antenna. The configuration may also indicate that an A-MPR should be applied. For instance, if the UE is to perform a dual-port transmission (e.g., transmit via two antennas), the BS may indicate an A-MPR to be applied for each antenna separately (e.g., different A-MPRs to be applied for the antennas) or indicate an amount of A-MPR to be used for both TX chains. For instance, the BS may indicate different A-MPRs for a primary antenna and a diversity antenna or the BS may indicate an amount of A-MPR to be used for both TX chains. Different A-MPR values may be configured for primary versus diversity antennas because the PA for each antenna may operate in different regions of a PA operating characteristic (e.g., different regions of an input power (Pin) versus output power (Pout) curve of the PA, including linear, saturation, or compression regions).

At block 1006, the UE may identify an MPR to be applied. For example, the UE may identify an MPR per an MPR table and use the A-MPR indicated by the BS (e.g., where the total MPR is the MPR per the MPR table plus the A-MPR). In some aspects, MPR tables are static and known by both the network and UE beforehand (e.g., stored in UE memory). The UE may look up the MPR from the table based on the configured waveform and modulation order (e.g., without additional signaling from the network). In contrast, A-MPR may be dynamic and signaled by the BS when the UE is scheduled to transmit. The UE may then perform the transmission 1008 with a transmit power as reduced per the identified total MPR.

### Example Operations

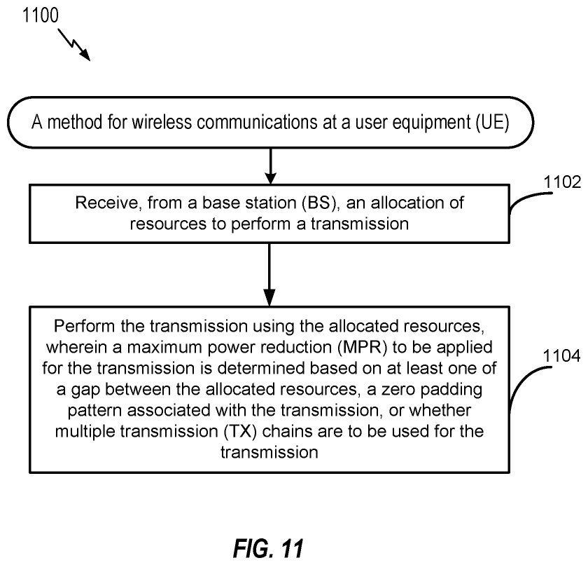

FIG. 11 shows an example of a method 1100 of wireless communications at a user equipment (UE), such as a UE 104 of FIGS. 1 and 3.

At block 1102, the UE may receive, from a network entity, an allocation of resources to perform a transmission. At block 1104, the UE may perform the transmission using the allocated resources. In some aspects of the present disclosure, a maximum power reduction (MPR) to be applied for the transmission is determined based on at least one of a gap between the allocated resources, a zero-padding pattern associated with the transmission, or whether multiple transmission (TX) chains are to be used for the transmission.

The MPR may be determined based on a number of resource blocks (RBs) in the gap between the allocated resources. For example, the MPR may be determined based on a ratio between the number of RBs and a number of RBs across a bandwidth (e.g., the sum of N_{gap} and N_{allocated} shown in FIG. 8) for the transmission. The MPR may be determined based on whether the ratio is less than a threshold (e.g., threshold γ_{i,k}). The threshold may be determined based on at least one a type of waveform to be used for the transmission or a type of the UE.

In some aspects, the MPR is determined based on the zero-padding pattern, the zero-padding pattern including a cyclic prefix insertion pattern, a zero-prefix pattern, or a zero-postfix pattern. The MPR may be determined further based on at least one of a number of padded zero samples to be used for the transmission (e.g., the ratio of padded zeros such as Q₁/N_{IFFT}, Q₂/N_{IFFT}, NCP/N_{IFFT}), modulation order, whether the allocated resources are contiguous or non-contiguous, or a size of a bandwidth associated with the transmission.

In some aspects, the MPR may be determined based on a level of correlation between the multiple TX chains. The UE may receive signaling (e.g., DCI, MAC-CE, or RRC signaling) providing: separate indications of additional MPR (A-MPR) to be applied for the transmission via the multiple TX chains, respectively; or an indication of an A-MPR to be applied for the transmission via the multiple TX chains.

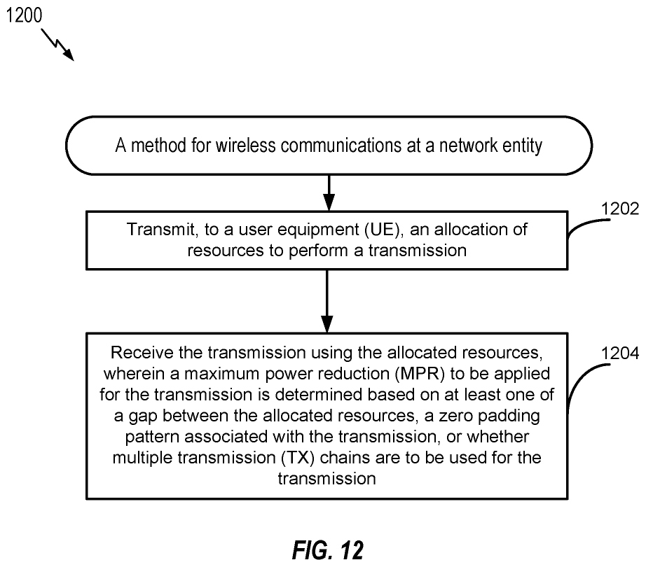

FIG. 12 shows an example of a method 1200 of wireless communications at a network entity, such as a BS 102 of FIGS. 1 and 3, or a disaggregated base station as discussed with respect to FIG. 2.

At block 1202, the network entity transmits, to a user equipment (UE), an allocation of resources to perform a transmission. At block 1204, the network entity receives the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

In some aspects, the MPR is determined based on a number of resource blocks (RBs) in the gap between the allocated resources. In some aspects, the MPR is determined based on a ratio between the number of RBs and a number of RBs across a bandwidth for the transmission. The MPR may be determined based on whether the ratio is less than a threshold, the threshold being determined based on at least one a type of waveform to be used for the transmission or a type of the UE.

In some aspects, the MPR is determined based on the zero-padding pattern, the zero-padding pattern including a cyclic prefix insertion pattern, a zero-prefix pattern, or a zero-postfix pattern. The MPR may be determined further based on at least one of a number of padded zero samples to be used for the transmission, modulation order, whether the allocated resources are contiguous or non-contiguous, or a size of a bandwidth associated with the transmission. In some aspects, the MPR is determined based on a level of correlation between the multiple TX chains. The BS may transmit signaling providing: separate indications of additional MPR (A-MPR) to be applied for the transmission via the multiple TX chains, respectively; or an indication of an A-MPR to be applied for the transmission via the multiple TX chains.

### Example Communications Device(s)

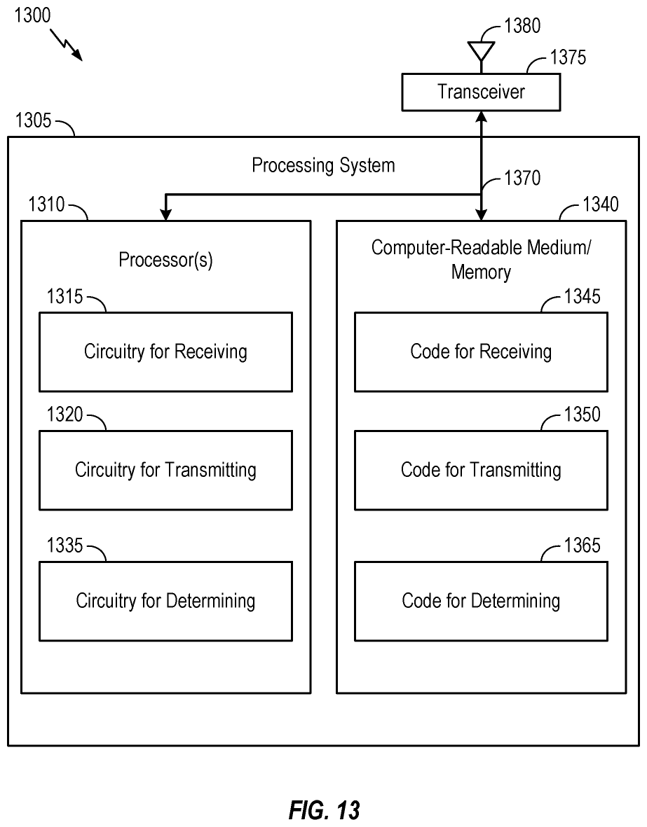

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to the transceiver 1375 (e.g., a transmitter and/or a receiver). The transceiver 1375 is configured to transmit and receive signals for the communications device 1300 via the antenna 1380, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1340 via a bus 1370. In certain aspects, the computer-readable medium/memory 1340 is configured to store instructions (e.g., computer-executable code) that when executed by the one or more processors 1310, cause the one or more processors 1310 to perform the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1340 stores code (e.g., executable instructions), such as code for receiving 1345 and code for transmitting 1350. Processing of the code for receiving 1345, code for transmitting 1350, and code for determining 1365 may cause the communications device 1300 to perform the method 1100 described with respect to FIG. 11, or any aspect related to it.

The one or more processors 1310 include circuitry configured to implement (e.g., execute) the code stored in the computer-readable medium/memory 1340, including circuitry such as circuitry for receiving 1315, circuitry for transmitting 1320, and circuitry for determining 1335. Processing with circuitry for receiving 1315, circuitry for transmitting 1320, and circuitry for determining 1335 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1375 and the antenna 1380 of the communications device 1300 in FIG. 13. Means for receiving or obtaining may include transceivers 354 and/or antenna(s) 352 of the UE 104 illustrated in FIG. 3 and/or the transceiver 1375 and the antenna 1380 of the communications device 1300 in FIG. 13.

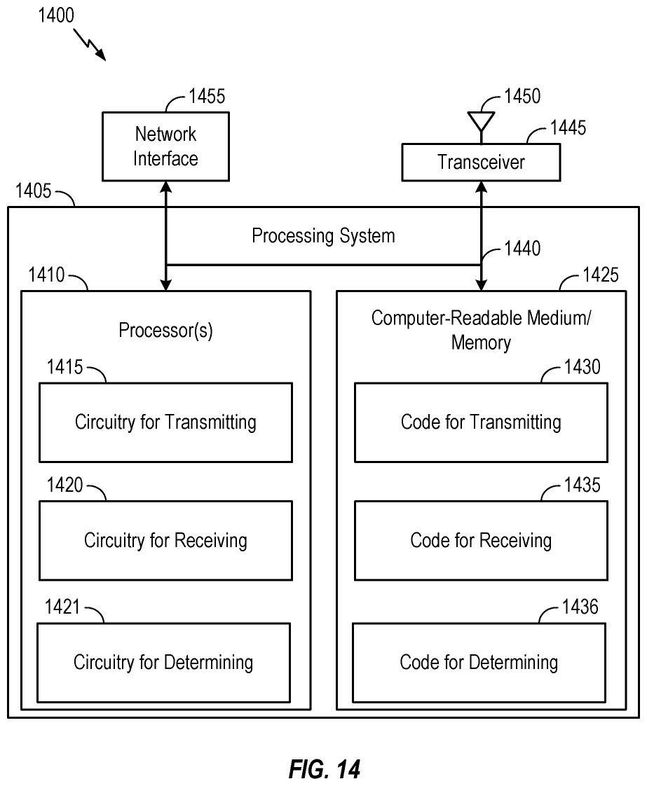

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1445 (e.g., a transmitter and/or a receiver) and/or a network interface 1455. The transceiver 1445 is configured to transmit and receive signals for the communications device 1400 via the antenna 1450, such as the various signals as described herein. The network interface 1455 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, or any aspect related to it. Note that reference to a processor of communications device 1400 performing a function may include one or more processors 1410 of communications device 1400 performing that function.

In the depicted example, the computer-readable medium/memory 1425 stores code (e.g., executable instructions), such as code for transmitting 1430, code for receiving 1435, and code for determining 1436. Processing of the code for transmitting 1430, code for receiving 1435 and code for determining 1436 may cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry such as circuitry for transmitting 1415, circuitry for receiving 1420, and circuitry for determining 1421. Processing with circuitry for transmitting 1415, circuitry for receiving 1420, and circuitry for determining 1421 may cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1445 and the antenna 1450 of the communications device 1400 in FIG. 14. Means for receiving or obtaining may include transceivers 332 and/or antenna(s) 334 of the BS 102 illustrated in FIG. 3 and/or the transceiver 1445 and the antenna 1450 of the communications device 1400 in FIG. 14.

### Example Clauses

Implementation examples are described in the following numbered clauses:

Aspect 1: A method for wireless communications at a user equipment (UE), comprising: receiving, from a network entity, an allocation of resources to perform a transmission; and performing the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

Aspect 2: The method of Aspect 1, wherein the MPR is determined based on a number of resource blocks (RBs) in the gap between the allocated resources.

Aspect 3: The method of Aspect 2, wherein the MPR is determined based on a ratio between the number of RBs and a number of RBs across a bandwidth for the transmission.

Aspect 4: The method of Aspect 3, wherein the MPR is determined based on whether the ratio is less than a threshold, the threshold being determined based on at least one a type of waveform to be used for the transmission or a type of the UE.

Aspect 5: The method according to any of Aspects 1-4, wherein the MPR is determined based on the zero-padding pattern, the zero-padding pattern including a cyclic prefix insertion pattern, a zero-prefix pattern, or a zero-postfix pattern.

Aspect 6: The method according to any of Aspects 1-5, wherein the MPR is determined further based on at least one of a number of padded zero samples to be used for the transmission, modulation order, whether the allocated resources are contiguous or non-contiguous, or a size of a bandwidth associated with the transmission.

Aspect 7: The method according to any of Aspects 1-6, wherein the MPR is determined based on a level of correlation between the multiple TX chains.

Aspect 8: The method according to any of Aspects 1-7, further comprising receiving signaling providing: separate indications of additional MPR (A-MPR) to be applied for the transmission via the multiple TX chains, respectively; or an indication of an A-MPR to be applied for the transmission via the multiple TX chains.

Aspect 9: A method for wireless communications at a network entity, comprising: transmitting, to a user equipment (UE), an allocation of resources to perform a transmission; and receiving the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

Aspect 10: The method of Aspect 9, wherein the MPR is determined based on a number of resource blocks (RBs) in the gap between the allocated resources.

Aspect 11: The method of Aspect 10, wherein the MPR is determined based on a ratio between the number of RBs and a number of RBs across a bandwidth for the transmission.

Aspect 12: The method of Aspect 11, wherein the MPR is determined based on whether the ratio is less than a threshold, the threshold being determined based on at least one a type of waveform to be used for the transmission or a type of the UE.

Aspect 13: The method according to any of Aspects 9-12, wherein the MPR is determined based on the zero-padding pattern, the zero-padding pattern including a cyclic prefix insertion pattern, a zero-prefix pattern, or a zero-postfix pattern.

Aspect 14: The method according to any of Aspects 9-13, wherein the MPR is determined further based on at least one of a number of padded zero samples to be used for the transmission, modulation order, whether the allocated resources are contiguous or non-contiguous, or a size of a bandwidth associated with the transmission.

Aspect 15: The method according to any of Aspects 9-14, wherein the MPR is determined based on a level of correlation between the multiple TX chains.

Aspect 16: The method according to any of Aspects 9-15, further comprising transmitting signaling providing: separate indications of additional MPR (A-MPR) to be applied for the transmission via the multiple TX chains, respectively; or an indication of an A-MPR to be applied for the transmission via the multiple TX chains.

Aspect 17: An apparatus, comprising: at least one memory comprising executable instructions; and at least one processor configured to execute the executable instructions and cause the apparatus to perform a method in accordance with any combination of Aspects 1-16.

Aspect 18: An apparatus, comprising means for performing a method in accordance with any combination of Aspects 1-16.

Aspect 19: A non-transitory computer-readable medium comprising executable instructions that, when executed by at least one processor of an apparatus, cause the apparatus to perform a method in accordance with any combination of Aspects 1-16.

Aspect 20: A computer program product embodied on a computer-readable storage medium comprising code for performing a method in accordance with any combination of Aspects 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for transmitting, means for taking, means for performing, and means for determining may comprise one or more processors, such as one or more of the processors described above.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications at a user equipment (UE), comprising:
receiving, from a network entity, an allocation of resources to perform a transmission; and
performing the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

2. The method of claim 1, wherein the MPR is determined based on a number of resource blocks (RBs) in the gap between the allocated resources.

3. The method of claim 2, wherein the MPR is determined based on a ratio between the number of RBs and a number of RBs across a bandwidth for the transmission.

4. The method of claim 3, wherein the MPR is determined based on whether the ratio is less than a threshold, the threshold being determined based on at least one a type of waveform to be used for the transmission or a type of the UE.

5. The method of claim 1, wherein the MPR is determined based on the zero-padding pattern, the zero-padding pattern including a cyclic prefix insertion pattern, a zero-prefix pattern, or a zero-postfix pattern.

6. The method of claim 1, wherein the MPR is determined further based on at least one of a number of padded zero samples to be used for the transmission, modulation order, whether the allocated resources are contiguous or non-contiguous, or a size of a bandwidth associated with the transmission.

7. The method of claim 1, wherein the MPR is determined based on a level of correlation between the multiple TX chains.

8. The method of claim 1, further comprising receiving signaling providing:
separate indications of additional MPR (A-MPR) to be applied for the transmission via the multiple TX chains, respectively; or
an indication of an A-MPR to be applied for the transmission via the multiple TX chains.

9. A method for wireless communications at a network entity, comprising:
transmitting, to a user equipment (UE), an allocation of resources to perform a transmission; and
receiving the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

10. The method of claim 9, wherein the MPR is determined based on a number of resource blocks (RBs) in the gap between the allocated resources.

11. The method of claim 10, wherein the MPR is determined based on a ratio between the number of RBs and a number of RBs across a bandwidth for the transmission.

12. The method of claim 11, wherein the MPR is determined based on whether the ratio is less than a threshold, the threshold being determined based on at least one a type of waveform to be used for the transmission or a type of the UE.

13. The method of claim 9, wherein the MPR is determined based on the zero-padding pattern, the zero-padding pattern including a cyclic prefix insertion pattern, a zero-prefix pattern, or a zero-postfix pattern.

14. The method of claim 9, wherein the MPR is determined further based on at least one of a number of padded zero samples to be used for the transmission, modulation order, whether the allocated resources are contiguous or non-contiguous, or a size of a bandwidth associated with the transmission.

15. The method of claim 9, wherein the MPR is determined based on a level of correlation between the multiple TX chains.

16. The method of claim 9, further comprising transmitting signaling providing:
separate indications of additional MPR (A-MPR) to be applied for the transmission via the multiple TX chains, respectively; or
an indication of an A-MPR to be applied for the transmission via the multiple TX chains.

17. An apparatus for wireless communication at user equipment (UE), comprising:
at least one memory comprising computer-executable instructions; and
one or more processors configured to execute the computer-executable instructions and cause the apparatus to:
receive, from a network entity, an allocation of resources to perform a transmission; and
perform the transmission using the allocated resources, wherein a maximum power reduction (MPR) to be applied for the transmission is determined based on at least one of a gap between the allocated resources, a zero-padding pattern associated with the transmission, or whether multiple transmission (TX) chains are to be used for the transmission.

18. The apparatus of claim 1, wherein one or more processors are configured to cause the apparatus to determine the MPR based on a number of resource blocks (RBs) in the gap between the allocated resources.

19. The apparatus of claim 18, wherein one or more processors are configured to cause the apparatus to determine the MPR based on a ratio between the number of RBs and a number of RBs across a bandwidth for the transmission.

20. The apparatus of claim 19, wherein one or more processors are configured to cause the apparatus to determine the MPR based on whether the ratio is less than a threshold, the threshold being determined based on at least one a type of waveform to be used for the transmission or a type of the UE.
